(19) United States
(12) Patent Application Publication
(10) Pub. No.: US 2023/0139415 A1
(43) Pub. Date: May 4, 2023

(54) SYSTEMS AND METHODS FOR IMPORTING AUDIO FILES IN A DIGITAL AUDIO WORKSTATION

(71) Applicant: Spotify AB, Stockholm (SE)

(72) Inventors: Rachel Malia BITTNER, Paris (FR); Sebastian EWERT, Berlin (DE); Ching SUNG, Brooklyn, NY (US); David Samuel RUBINSTEIN, Brooklyn, NY (US); Joakim Christer PERSSON, Stockholm (SE); Peter Milan Thomson SOBOT, New York, NY (US); Sourabh PATERIYA, Stockholm (SE); George Edward MILLS, Stockholm (SE)

(21) Appl. No.: 17/515,179

(22) Filed: Oct. 29, 2021

(51) Int. Cl. G10H 1/00; G10H 1/40

(52) U.S. Cl. CPC G10H 1/0066; G10H 1/0008; G10H 1/40; G10H 2250/311; G10H 2220/126; G10H 2220/106

(57) ABSTRACT

A method includes displaying a user interface of a digital audio workstation, which includes a composition region for generating a composition. The composition region includes a representation of a first MIDI file that has already been added to the composition by a user. The method further includes receiving a user input to import, into the composition region, an audio file. In response to the user input to import the audio file, the method includes importing the audio file, which includes, without user intervention, aligning the audio file with a rhythm of the first MIDI file, modifying a rhythm of the audio file based on the rhythm of the first MIDI file, and displaying a representation of the audio file in the composition region.

### TECHNICAL FIELD

The disclosed embodiments relate generally to importing audio files in a digital audio workstation (DAW), and more particularly, to aligning and modifying the imported audio file based on an existing file in the DAW.

### BACKGROUND

A digital audio workstation (DAW) is an electronic device or application software used for recording, editing and producing audio compositions. DAWs come in a wide variety of configurations from a single software program on a laptop, to an integrated stand-alone unit, all the way to a highly complex configuration of numerous components controlled by a central computer. Regardless of configuration, modern DAWs generally have a central interface that allows the user to alter and mix multiple recordings and tracks into a final produced piece.

DAWs are used for the production and recording of music, songs, speech, radio, television, soundtracks, podcasts, sound effects and nearly any other situation where complex recorded audio is needed. MIDI, which stands for “Musical Instrument Digital Interface” is a common data protocol used for manipulating audio using a DAW.

Automatic Music Transcription (AMT) systems are typically used to transcribe audio into a digital form. Many recent advancements in AMT were enabled by specializing for a single instrument, such as piano, guitar, or singing voice. While there have been some attempts for instrument-agnostic (e.g., not built for a specific instrument) AMT systems, such implementations typically require increased computational resources (e.g., retraining), rendering it more difficult to run efficiently, particularly on low-end devices.

### SUMMARY

The disclosed embodiments relate to systems and methods for creating a MIDI file from a musical audio file (e.g., performing AMT). In particular, some embodiments of the present disclosure provide a neural network architecture that is polyphonic (supports multiple notes at a time) and instrument agnostic (e.g., trainable for a variety of instruments). The neural network is lightweight enough to run in real-time or near real-time, and is efficient (e.g., with less than 40 megabytes (MB) of peak memory usage). This neural network allows a user to record, e.g., their voice, a guitar, or any number of other instruments, convert it to MIDI, and then edit the resulting MIDI file. In addition, in some embodiments, when a user imports an audio file into an existing composition, the system aligns the audio file with the existing MIDI file (e.g., by first applying the changes to a generated MIDI file, and then back to the audio file) and modifies the rhythm of the audio file to match the MIDI file. The user can also export the entire composition, including the audio file, to a notation format.

To that end, in accordance with some embodiments, a method is performed at an electronic device. The method includes displaying, on a display of an electronic device, a user interface of a digital audio workstation (DAW). The user interface for the DAW includes a composition region for generating a composition, and the composition region includes a representation of a first MIDI file that has already been added to the composition by a user. The method includes receiving a user input to import, into the composition region, an audio file. The method includes, in response to the user input to import the audio file, importing the audio file, including, without user intervention, aligning the audio file with a rhythm of the first MIDI file, modifying a rhythm of the audio file based on the rhythm of the first MIDI file, and displaying a representation of the audio file in the composition region.

Further, some embodiments provide an electronic device. The device includes a display, one or more processors and memory storing one or more programs including instructions for performing any of the methods described herein.

Further, some embodiments provide a non-transitory computer-readable storage medium storing one or more programs configured for execution by an electronic device. The one or more programs include instructions that, when executed by the electronic device, cause the electronic device to perform any of the methods described herein.

Thus, systems are provided with improved methods for generating audio content in a digital audio workstation.

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a computing environment, in accordance with some embodiments.

FIG. 2 is a block diagram illustrating a client device, in accordance with some embodiments.

FIG. 3 is a block diagram illustrating a digital audio composition server, in accordance with some embodiments.

FIG. 4 illustrates an example of a neural network architecture for automatic music transcription, in accordance with some embodiments.

FIGS. 5A-5B illustrate examples of graphical user interfaces for a digital audio workstation that includes a composition region where a user may import an audio file, in accordance with some embodiments.

FIGS. 6A-6C are flow diagrams illustrating a method of importing an audio file into a digital audio workstation (DAW), in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc., are, in some instances, used herein to describe various elements, these elements should not be limited by these terms. These terms are used only to distinguish one element from another. For example, a first user interface element could be termed a second user interface element, and, similarly, a second user interface element could be termed a first user interface element, without departing from the scope of the various described embodiments. The first user interface element and the second user interface element are both user interface elements, but they are not the same user interface element.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

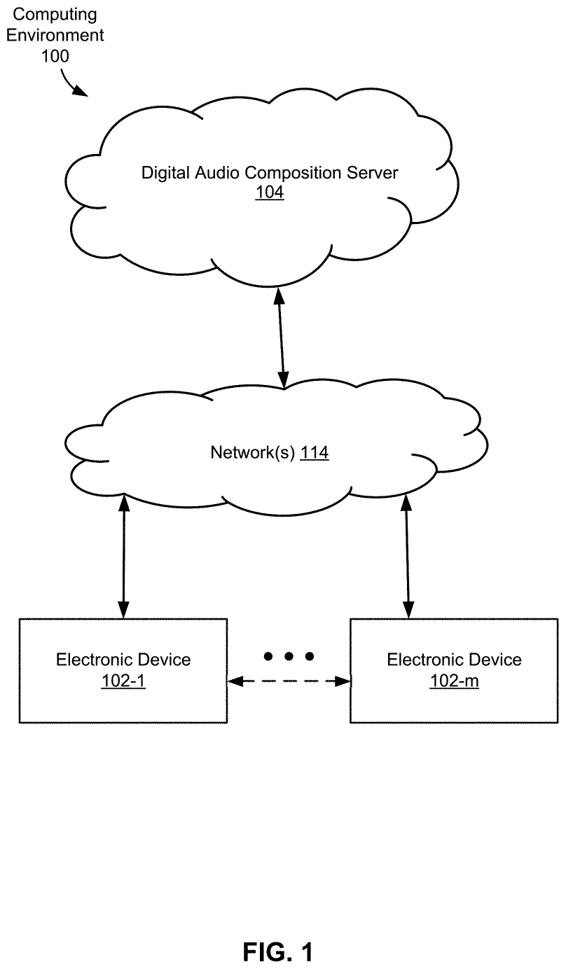

FIG. 1 is a block diagram illustrating a computing environment 100, in accordance with some embodiments. The computing environment 100 includes one or more electronic devices 102 (e.g., electronic device 102-1 to electronic device 102-m, where m is an integer greater than one) and one or more digital audio composition servers 104.

The one or more digital audio composition servers 104 are associated with (e.g., at least partially compose) a digital audio composition service (e.g., for collaborative digital audio composition) and the electronic devices 102 are logged into the digital audio composition service. An example of a digital audio composition service is SOUNDTRAP™, which provides a collaborative platform on which a plurality of users can modify a collaborative composition.

One or more networks 114 communicably couple the components of the computing environment 100. In some embodiments, the one or more networks 114 include public communication networks, private communication networks, or a combination of both public and private communication networks. For example, the one or more networks 114 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, digital media player, a speaker, television (TV), digital versatile disk (DVD) player, and/or any other electronic device capable of presenting media content (e.g., controlling playback of media items, such as music tracks, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices. In some embodiments, electronic device 102-1 (e.g., or electronic device 102-2 (not shown)) includes a plurality (e.g., a group) of electronic devices.

In some embodiments, electronic devices 102-1 and 102-m send and receive audio composition information through network(s) 114. For example, electronic devices 102-1 and 102-m send requests to add or remove notes, instruments, or effects to a composition, to 104 through network(s) 114.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., Bluetooth/Bluetooth Low Energy (BLE)) communication technologies, radio-frequency-based near-field communication technologies, infrared communication technologies, etc.) with electronic device 102-m. In some embodiments, electronic device 102-1 communicates with electronic device 102-m through network(s) 114. In some embodiments, electronic device 102-1 uses the direct connection with electronic device 102-m to stream content (e.g., data for media items) for playback on the electronic device 102-m.

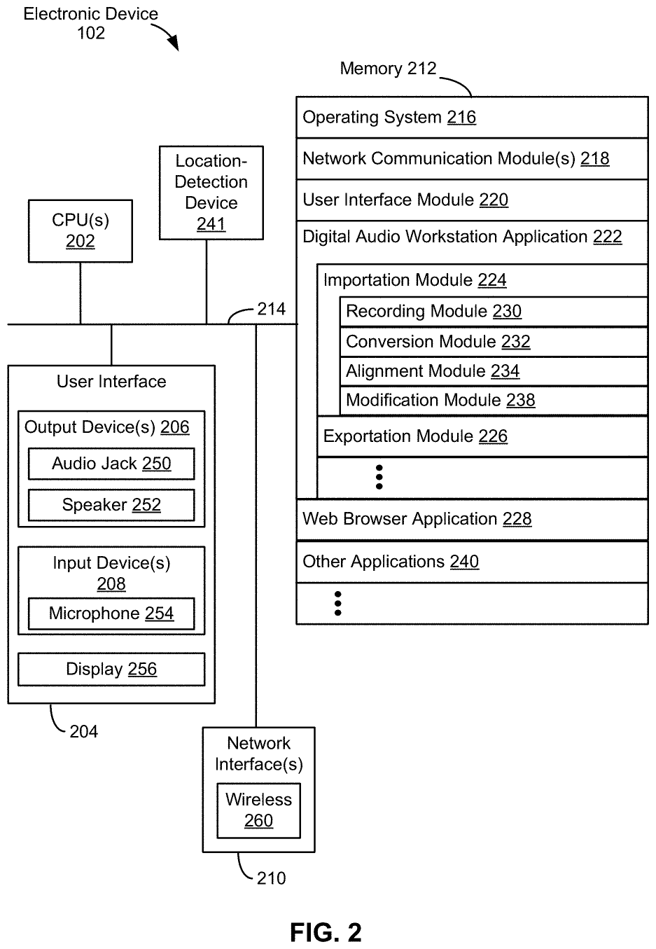

In some embodiments, electronic device 102-1 and/or electronic device 102-m include a digital audio workstation application 222 (FIG. 2) that allows a respective user of the respective electronic device to upload (e.g., to digital audio composition server 104), browse, request (e.g., for playback at the electronic device 102), select (e.g., from a recommended list) and/or modify audio compositions (e.g., in the form of MIDI files).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard (e.g., a keyboard with alphanumeric characters), mouse, track pad, a MIDI input device (e.g., a piano-style MIDI controller keyboard) or automated fader board for mixing track volumes. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone 254) to capture audio (e.g., vocals from a user).

Optionally, the electronic device 102 includes a location-detection device 241, such as a global navigation satellite system (GNSS) (e.g., GPS (global positioning system), GLONASS, Galileo, BeiDou) or other geo-location receiver, and/or location-detection software for determining the location of the electronic device 102 (e.g., module for finding a position of the electronic device 102 using trilateration of measured signal strengths for nearby devices).

In some embodiments, the one or more network interfaces 210 include wireless and/or wired interfaces for receiving data from and/or transmitting data to other electronic devices 102, a digital audio composition server 104, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, and/or or other wireless (e.g., Bluetooth-compatible) devices (e.g., for streaming audio data to the electronic device 102 of an automobile). Furthermore, in some embodiments, the wireless interface 260 (or a different communications interface of the one or more network interfaces 210) enables data communications with other WLAN-compatible devices (e.g., electronic device(s) 102) and/or the digital audio composition server 104 (via the one or more network(s) 114, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., other electronic device(s) 102, and/or digital audio composition server 104) via the one or more network interface(s) 210 (wired or wireless) connected to one or more network(s) 114;
a user interface module 220 that receives commands and/or inputs from a user via the user interface 204 (e.g., from the input devices 208) and provides outputs for playback and/or display on the user interface 204 (e.g., the output devices 206). The user interface module 220 also includes a display (256) for displaying a user interface for one or more applications;
a digital audio workstation application 222 (e.g., recording, editing, suggesting and producing audio files such as musical composition). Note that, in some embodiments, the term “digital audio workstation” or “DAW” refers to digital audio workstation application 222 (e.g., a software component). In some embodiments, digital audio workstation application 222 also includes the following modules (or sets of instructions), or a subset or superset thereof:
   an importation module 224 for importing different types of files (e.g., audio files) into the DAW. In some embodiments, the importation module 224 also includes the following modules (or sets of instructions), or a subset or superset thereof:
      a recording module 230 for recording audio input via the user interface 204 (e.g., from the input devices 208). In some embodiments, the recorded audio information is saved in memory 212 as audio file(s);
      a conversion module 232 for converting one type of file into another type of file. In some embodiments, the conversion module 232 is able to convert audio file(s) into MIDI file(s);
      an alignment module 234 for aligning audio file(s) with MIDI file(s) based on certain criteria. In some embodiments, some of the criteria may be provided by a user through user interface 204;
      a modification module 238 for modifying audio files and/or MIDI file(s) based on instructions. In some embodiments, some of the instructions may be provided by a user through user interface 204.
an exportation module 226 for exporting different types of files in DAW to a particular output format based on certain instructions. In some embodiment, part of the instructions to export may be provided by a user through user interface 204.
a web browser application 228 (e.g., Internet Explorer or Edge by Microsoft, Firefox by Mozilla, Safari by Apple, and/or Chrome by Google) for accessing, viewing, and/or interacting with web sites. In some embodiments, rather than digital audio workstation application 222 being a stand-alone application on electronic device 102, the same functionality is provided through a web browser logged into a digital audio composition service;
other applications 240, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

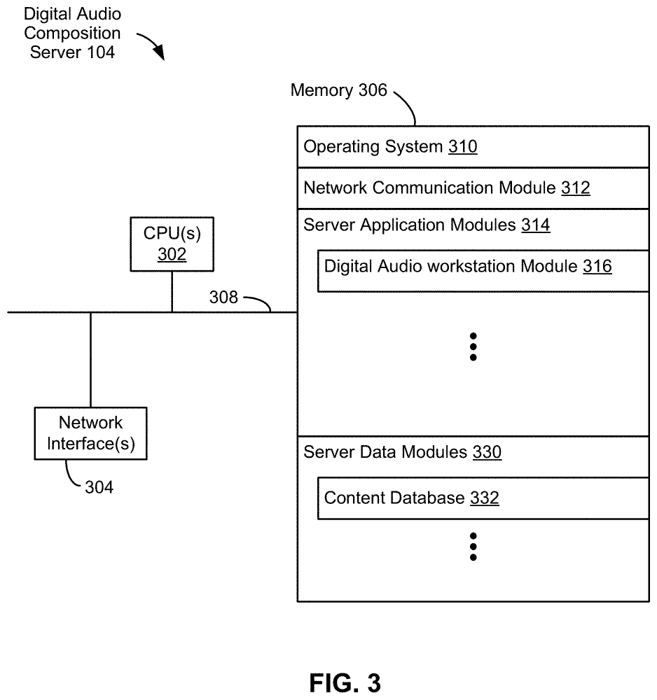

FIG. 3 is a block diagram illustrating a digital audio composition server 104, in accordance with some embodiments. The digital audio composition server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the digital audio composition server 104 to other computing devices via one or more network interfaces 304 (wired or wireless) connected to one or more networks 114;
one or more server application modules 314 for performing various functions with respect to providing and managing a content service, the server application modules 314 including, but not limited to, one or more of:
   digital audio workstation module 316 which may share any of the features or functionality of digital audio workstation module 222. In the case of digital audio workstation module 316, these features and functionality are provided to the client device 102 via, e.g., a web browser (web browser application 228);
one or more server data module(s) 330 for handling the storage of and/or access to media items and/or metadata relating to the audio compositions; in some embodiments, the one or more server data module(s) 330 include a media content database 332 for storing audio compositions.

In some embodiments, the digital audio composition server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above. In some embodiments, memory 212 stores one or more of the above identified modules described with regard to memory 306. In some embodiments, memory 306 stores one or more of the above identified modules described with regard to memory 212.

Although FIG. 3 illustrates the digital audio composition server 104 in accordance with some embodiments, FIG. 3 is intended more as a functional description of the various features that may be present in one or more digital audio composition servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. The actual number of servers used to implement the digital audio composition server 104, and how features are allocated among them, will vary from one implementation to another and, optionally, depends in part on the amount of data traffic that the server system handles during peak usage periods as well as during average usage periods.

Some embodiments of the present disclosure provide an Automatic Music Transcription (AMT) model for polyphonic instruments that generalizes across a set of instruments without retraining, while being lightweight enough to run in low-resource settings, such as a web browser. To achieve so, both the speed and the peak memory usage when running inference may be considered. In some embodiments, common architecture choices such as long short-term memory (LSTM) layer are avoided. In some embodiments, a shallow architecture is used to keep the memory needs low and the speed fast. It is noted that the number of parameters of a model does not necessarily correlate with its memory usage. For example, while a convolution layer requires few parameters, it might still have a high memory usage due to the memory required for each feature map.

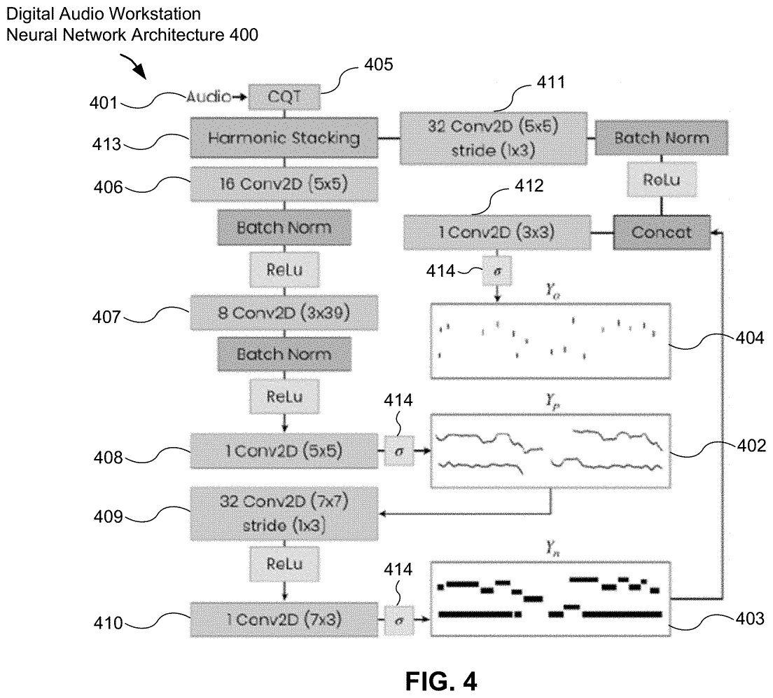

FIG. 4 illustrates an example of a neural network architecture for automatic music transcription in accordance with some embodiments. In particular, the architecture illustrated in FIG. 4 is a fully convolutional architecture including a plurality of convolutional layers (e.g., convolutional layers 406-412). In some embodiments, the architecture 400 takes audio as input 401, producing three posterior outputs 402, 403, and 404, with a total of only 16,782 parameters. In some embodiments, the architecture's three outputs 402, 403, and 404 are time-frequency matrices encoding (1) whether an onset associated with a note is taking place Yₒ 404, (2) a note is active Yₙ 403 and (3) a pitch contour is active Yₚ 402. In FIG. 4, the symbol σ 414 indicates a sigmoid activation.

In some embodiments, all three outputs have the same number of time frames as the input constant Q transformation (CQT) 405 but may be different in frequency resolution. For example, in some embodiments, both Yₒ 404 and Yₙ 403 have a resolution of 1 bin per semitone while Yₚ 402 has a resolution of 3 bins per semitone. Besides having different frequency resolutions, in some embodiments, Yₙ 403 and Yₚ 402 are trained to capture different concepts: Yₙ 403 captures frame-level note event information “musically quantized” in time and frequency, while Yₚ 402 encodes frame-level pitch information. During training, the target data for each of these outputs 402, 403, and 404 are binary matrices generated from ground truth note and pitch annotation.

In some embodiments, the architecture 400 is structured to exploit the differing properties of the three outputs 402, 403, and 404. First, in order to estimate Yₚ 402, the architecture 400 uses a similar approach to the one depicted in R. M. Bittner, B. McFee, J. Salamon, P. Li, and J. P. Bello, “Deep salience representations for FO estimation in polyphonic music,” in Proc. the 18th International Society for Music Information Retrieval Conference, ISMIR, 2017, pp. 63-70. In some embodiments, the architecture 400 may use fewer convolutional layers to reduce memory usage. Notably, in some embodiments, it is helpful to employ the same octave plus one semitone size kernel in frequency to avoid octave mistakes. This stack of convolutions can be interpreted as “denoising,” in order to emphasize the multipitch posterior outputs and de-emphasize transients, harmonics and other unpitched content. In some embodiments, Yₙ 403 is computed directly using Yₚ 402 as an input, followed by two small convolutional layers 409 and 410. These convolutions can be seen as “musical quantization” layers, learning how to perform the nontrivial grouping of pitch contour posteriors into note event posteriors. In some embodiments, Yₒ 404 is estimated using both Yₙ 403 and convolutional features computed from the audio, which are necessary to identify transients, as input 401.

In some embodiments, given the input audio 401, the architecture first computes a Constant-Q Transform (CQT) 405 with 3 bins per semitone and a hop size of about 11 ms. In some embodiments, rather than using, e.g., a Mel spectrogram and learning the projection into a log-spaced frequency scale using a dense or LSTM layer (which requires the model to have a full-frequency receptive field), this step can be avoided entirely by starting with a representation with the desired frequency scale. An additional benefit to not needing a full-frequency receptive field is that it removes the need for pitch shifting data augmentations. Harmonic Stacking 413 generates a Harmonic CQT (HCQT), which is a 3-dimensional transformation of the CQT 405 which aligns harmonically-related frequencies along the 3rd dimension, allowing small convolutional kernels to capture harmonically related information. In some embodiments, to achieve efficient approximation of the HCQT, for each harmonic, the input CQT 405 is copied and shifted vertically by the number of frequency bins corresponding to the harmonic, e.g., 12 semitones for the first harmonic, rounding when necessary. In some embodiments, 7 harmonics and 1 sub-harmonic may be used.

In some embodiments, in order to encourage desirable properties of the outputs 402, 403, and 404, various regularizers may be used. In some embodiments, an L₁ penalty is imposed on all three outputs 402, 403, and 404 to encourage the outputs to be sparse. In addition, in some embodiments, for Yₙ 403, an L₁ penalty may also be imposed on the first order differences in time, in order to encourage the total variation to be small—i.e., so that the outputs are smooth horizontally.

In some embodiments, loss functions are used for the three outputs 402, 403, and 404. Specifically, in some embodiments, binary cross entropy may be used for all three outputs. However, for Yₒ 404, there is an extremely heavy imbalance between the positive and negative classes, and during training, models tended to output Yₒ=0. As a countermeasure, in some embodiments, a class-balanced cross entropy loss is used. For example, in some embodiments, the weight for the positive class is smaller than that of the negative class. Specifically, in some embodiments, the weight for the positive class may be 0.05 and the negative is 0.95. Such weight assignment may be set empirically by observing the properties of the resulting Yₒ 404. The goal is to encourage the model to fit the onset while still maintaining output sparsity.

In some embodiments, inference is performed in the memory of an electronic device (e.g., Memory 212 of Electronic Device 102). Training may be performed on a server (e.g., Digital Audio Composition Server 104, or a different server). Note, however, that in some embodiments, inference may be performed on the server as well (e.g., by passing audio from an electronic device 102 to digital audio composition server 104). In some embodiments, for example, during training, the model achieved by the architecture 400 takes 2 seconds of audio with a sample rate of 22050 Hz as input 401. In some embodiments, the model may be trained with a batch size of 16 with 100 steps per epoch. In some embodiments, an Adam optimizer may be used with a learning rate of 0.001. In some embodiments, during inference, audio input 401 may be framed into 2-second windows with an overlap of 30 bins (twice the length of the model's respective field in time), and the outputs are concatenated using the center half of the output window.

In some embodiments, note or contour creation post-processing methods are used. Note events are created, defined by a start time t⁰, and end time t¹ and a pitch f by running a post-processing step using Yₒ 404 and Yₙ 403 as input. In some embodiments, a set of onsets {(tᵢ⁰, fᵢ)} are populated by peak picking across the time for each frequency bin of Yₒ 404, and peaks with amplitude>0.5. Note events are created for each i in descending order of tᵢ⁰, by advancing forward in time through Yₙ 403 until the amplitude of Yₙ 403 falls below a threshold τₙ for longer than an allowed tolerance (e.g., 11 frames), then ending the note. When notes are created, the amplitude of all corresponding frames of Yₙ 403 are set to 0. After all onsets have been used, additional note events are created by iterating through bins of Yₙ 403 that have amplitude>τₙ in order of descending amplitude. The same note creation procedure is followed as before, but instead, both forward and backward in time are traced. Finally, note events which are shorter than a specified duration (e.g., around 120 ms) are removed.

In some embodiments, given a note event (tᵢ⁰, tᵢ¹, fᵢ), pitch bends are estimated per frame using Yₚ 402. Let pᵢ be the frequency bin in Yₚ 402 corresponding to The bin \hat{p}ᵢ of Yₚ 402 corresponding to the peak in frequency nearest to pᵢ is selected for each time frame. Then, the pitch bend bᵢ (in units of number of frequency bins of Yₚ 402) is estimated by computing a weighted average of the neighboring bins as:

$${b}_{i} = \frac{{\sum }_{k = - 1 , 0 , 1} {Y}_{p} [ {t}_{i}^{0} , {\hat{p}}_{i} + k ] ( {\hat{p}}_{i} + k )}{{\sum }_{k = - 1 , 0 , 1} {Y}_{p} [ {t}_{i}^{0} , {\hat{p}}_{i} + k ]} - {p}_{i}$$

bᵢ can be converted to semitones by dividing by 3 (the number of bins per semitone in Yₚ 402).

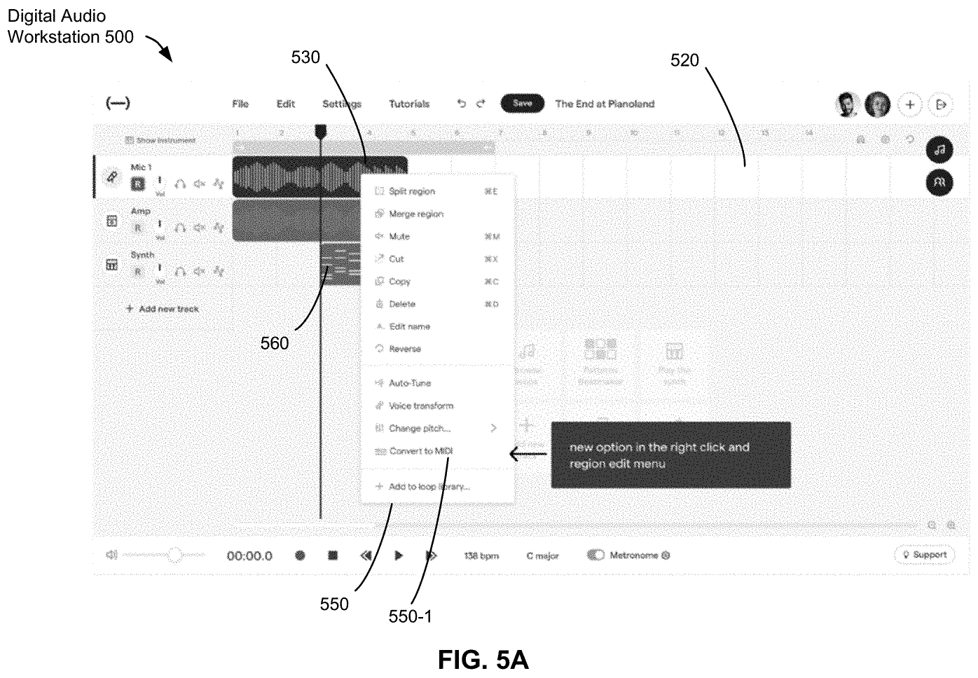

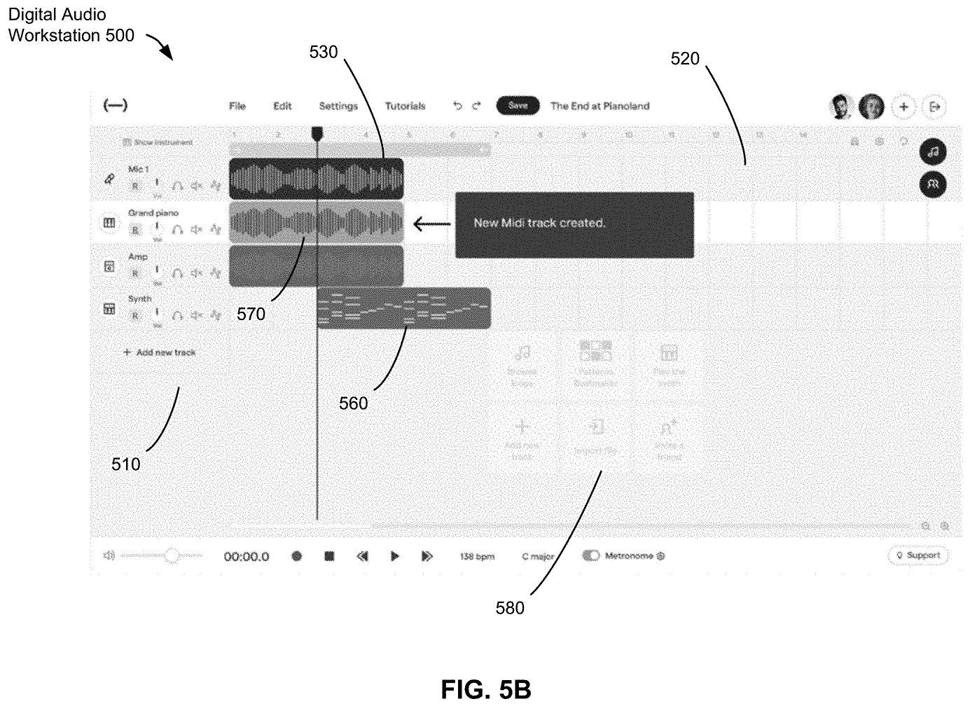

FIGS. 5A-5B illustrate examples of graphical user interfaces for a digital audio workstation that includes a composition region into which a user may import an audio file, in accordance with some embodiments. In particular, FIG. 5A illustrates a graphical user interface comprising a composition region 520 for generating a composition. The user may add different compositional segments (e.g., segments 530 and 560) and edit the added compositional segments. In some embodiments, the compositional segments may include audio segments and MIDI segments. For example, compositional segment 530 is an audio segment (e.g., comprising audio received from a microphone), whereas compositional segment 560 is a MIDI segment (comprising digitized notes). Together, the compositional segments form a composition.

In some embodiments, the audio file represented by segment 530 is imported from an existing audio file. Alternatively, the audio file represented by segment 530 is imported by recording audio (e.g., through a microphone). As the audio file is recorded (e.g., in real-time), segment 530 expands horizontally, indicating the length of the audio file that has already been recorded.

As shown in FIG. 5A, segment 560 is a representation of a first MIDI file in the composition region 520. Segment 530 is a representation of an audio file that is imported by a user into the composition region 520.

In some embodiments, a user may right click on the segment 530 (or the corresponding profile section), and a region edit menu 550 including one or more options is displayed. The user may further select one of the one or more options provided in the region edit menu 550 to perform a corresponding function associated with segment 530. In some embodiments, one of the options provided in the region edit menu 550 allows the user to convert segment 530, which is the representation of the audio file, into a second MIDI file. For example, such conversion from an audio file to a MIDI file may be initiated by the user selecting a “Convert to MIDI” option 550-1. In some embodiments, such conversion from an audio file into a MIDI file is performed automatically (e.g., without user intervention) upon importing the audio file (e.g., as soon as the recording is completed, or as the audio file is being recorded (e.g., in real-time)).

In some embodiments, once conversion from an audio file into a MIDI file is initiated, the audio file is input into the model achieved by the DAW neural network architecture 400, and eventually converted into a second MIDI file. The second MIDI file includes MIDI notes corresponding to the audio file. In some embodiments, the digitized notes of the second MIDI file are aligned with a rhythm of the first MIDI file (e.g., notes from the second MIDI are aligned by a computer system, such as the computer system displaying the graphical user interface or by a server system in communication with the computer system displaying the graphical user interface).

In some embodiments, once the audio file has been converted to the second MIDI file, any of number of other operations may be performed (as an alternative to, or in addition to, aligning the second MIDI file with the rhythm of the first MIDI file). In some embodiments, audio content corresponding to the second MIDI file can be edited, either by the user or automatically (e.g., without the user specifying the modifications, so that the second MIDI file “fits” better within the composition). In some embodiments, when the second MIDI file (or the entire composition) is played back, the DAW may provide a visual indication of which notes are being played (e.g., by highlighting displayed piano keys). In some embodiments, the DAW may automatically mark “wrong” notes (e.g., out-of-tune notes or notes that do not match the chord), e.g., by displaying them in a different color. In some embodiments, the user can request that the DAW indicate differences between “takes” (e.g., attempts to record the same portion of a composition). The DAW may then provide a visual indication of where two audio files (e.g., two “takes”), each of which have been converted to MIDI, differ.

FIG. 5B illustrates the same graphical user interface as shown in FIG. 5A, except that the resulting second MIDI file is displayed in the composition region 520. Segment 570 is a representation of the second MIDI file converted from the audio file represented by segment 530. The representation of the second MIDI file is different from that of the audio file, indicating that a MIDI file is different from an audio file. Such distinction, for example, may be illustrated by an icon, color of the segments, and/or shade of the segments. The representation of the second MIDI file also shares certain attributes with that of the audio file, indicating that the second MIDI file is associated with (e.g., converted from) the audio file. For example, as shown in FIG. 5B, the representation of the audio file (segment 530) shares the same color (e.g., purple) with the representation of the resulting second MIDI file (segment 570), indicating that the second MIDI file corresponding to segment 570 is associated with (e.g., converted from) the audio file corresponding to segment 530. However, at the same time, segment 530 and segment 570 are different in shade, indicating that segment 530 and segment 570 correspond to different files—segment 530 corresponds to an audio file and segment 570 corresponds to a MIDI file.

In some embodiments, the profile section 510 may provide more information with respect to the second MIDI file. For example, the DAW may be able to determine what instrument the audio file is recorded from. As shown in FIG. 5B, the profile section 510 displays “Grand piano” at a location corresponding to segment 570, indicating that the audio file from which the second MIDI file is converted from is recorded from a grand piano.

In some embodiments, when the audio file is converted into the second MIDI file in real-time (e.g., as the audio file is recorded), segment 570 expands horizontally, following the expansion of segment 530, indicating how much of the recorded audio file has been converted into MIDI. As the audio file is recorded and segment 530 expands, an indication of the MIDI notes of the second MIDI file is displayed. In some embodiments, the indication is displayed at a predetermined location within the graphical user interface 500, or over segment 530 and/or segment 570.

In some embodiments, the representation of the resulting second MIDI file 570 is not displayed while the conversion from the audio file into the second MIDI file is still being performed.

In some embodiments, as shown in FIG. 5B, the user may select the “Import file” option 580 in the DAW user interface 500. Recording of the audio file represented by segment 530 may be initiated automatically (e.g., without user intervention). Alternatively, the user may be presented with at least an option to import from an existing file and an option to import by recording.

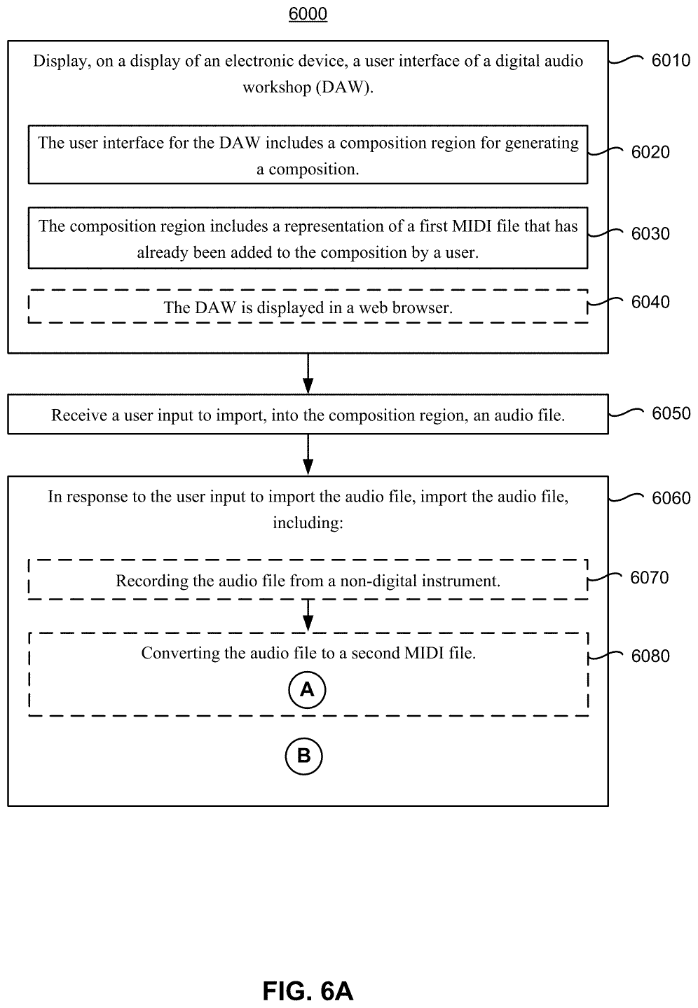

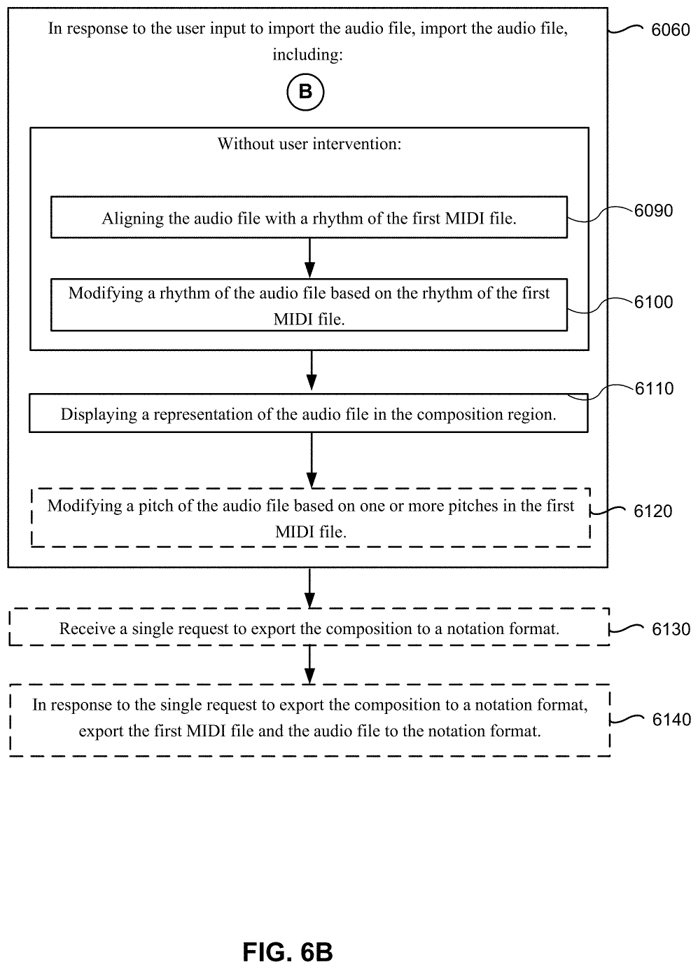

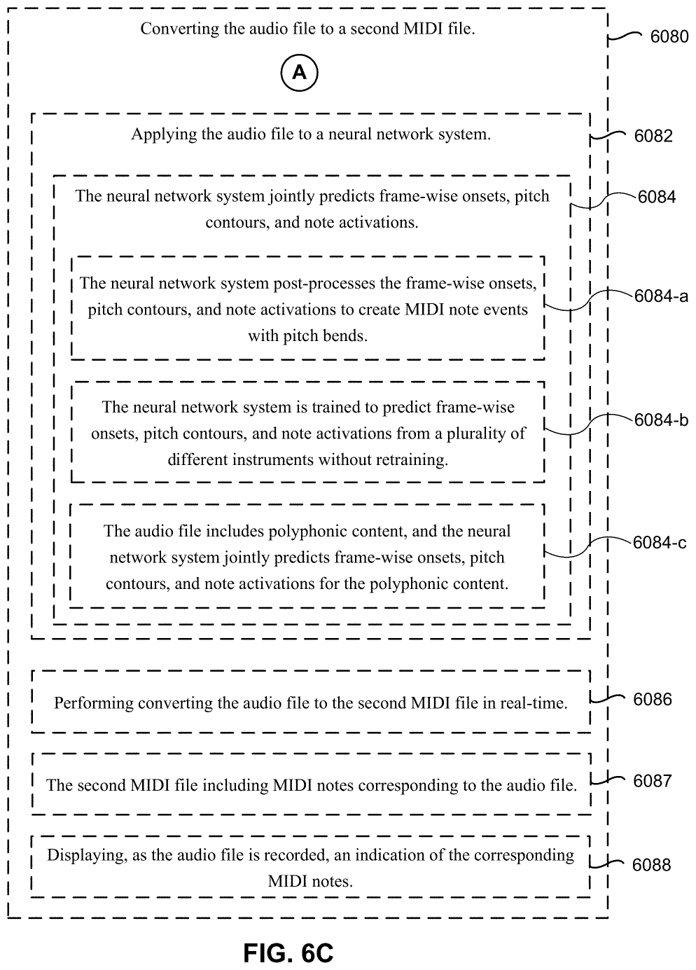

FIGS. 6A-6C are flow diagrams illustrating a method 6000 of importing an audio file in a digital audio workstation (DAW), in accordance with some embodiments. Method 6000 may be performed at an electronic device (e.g., electronic device 102). The electronic device includes a display, one or more processors, and memory storing one or more programs including instructions for execution by the one or more processors. In some embodiments, the method 6000 is performed by executing instructions stored in the memory (e.g., memory 212, FIG. 2) of the electronic device. In some embodiments, the method 6000 is performed by a combination of a server system (e.g., including digital audio composition server 104) and a client electronic device (e.g., electronic device 102, logged into a service provided by the digital audio composition server 104).

Method 6000 includes displaying (6010), on a display of an electronic device (e.g., display 256), a user interface (e.g., user interface 204) of a digital audio station (DAW), wherein the user interface for the DAW includes (6020) a composition region (e.g., composition region 520) for generating a composition, and the composition region includes (6030) a representation of a first MIDI file (e.g., segment 560) that has already been added to the composition by a user.

In some embodiments, the DAW is displayed (6040) in a web browser (e.g., web browser application 228).

In some embodiments, method 6000 further comprises receiving (6050) a user input to import, into the composition region, an audio file. In response to the user input to import the audio file, method 6000 further comprises importing (6060) the audio file (e.g., represented by segment 530).

In some embodiments, importing (6060) the audio file includes recording (6070) the audio file from a non-digital instrument (e.g., voice, guitar, piano, etc.). In some embodiments, the user may provide an input (e.g., select a recording button 540-1) in order to start recording the audio file. In some embodiments, importing (6060) the audio file includes selecting an existing audio file from the electronic device 102. In some embodiments, the existing audio file may be transferred to the electronic device from another memory or device (e.g., copied from a different drive, or downloaded from a website), or recorded by the electronic device 102 via the input device(s) 208. In some embodiments, recording such an existing audio file is performed by the Digital Audio Workstation Application 222 or by one of Other Applications 240.

In some embodiments, importing (6060) the audio file includes converting (6080) the audio file to a second MIDI file (e.g., represented by segment 570). In some embodiments, the second MIDI file remains invisible to the user (e.g., the DAW's composition region does not display a representation of the second MIDI file). In this manner, MIDI-style changes (e.g., changes to note placement, velocity, etc.) may be made to the second MIDI file and applied to the audio file while the audio file still appears as audio (rather than MIDI) to the user. In some embodiments, converting the audio file to a second MIDI file is performed automatically (e.g., without user intervention) in response to the user input to import the audio file (e.g., select the “Import file” option 580).

In some embodiments, converting (6080) the audio file to a second MIDI file includes applying (6082) the audio file to a neural network system (e.g., DAW neural network architecture 400). In some embodiments, applying (6082) the audio file to a neural network system is performed automatically (e.g., without user intervention) once converting (6080) the audio file to a second MIDI file has started. Alternatively, applying the audio file to the neural network system is performed in response to a user input (e.g., select the “Convert to MIDI” option 550-1).

In some embodiments, the neural network system jointly predicts (6084) frame-wise onsets, pitch contours, and note activations. In some embodiments, the neural network system post-processes (6084-a) the frame-wise onsets, pitch contours, and note activations to create MIDI note events with pitch bends. In some embodiments, the neural network system is trained to predict (6084-b) frame-wise onsets, pitch contours, and note activations from a plurality of different instruments without retraining. In some embodiments, the audio file includes (6084-c) polyphonic content, and the neural network system jointly predicts frame-wise onsets, pitch contours, and note activations for the polyphonic content.

In some embodiments, converting (6080) the audio file (e.g., represented by segment 530) to a second MIDI file (e.g., represented by segment 570) includes performing (6086) converting the audio file to the second MIDI file in real-time (e.g., as the audio file is recorded). In some embodiments, the second MIDI file includes (6087) MIDI notes corresponding to the audio file. In some embodiments, converting (6080) the audio file to a second MIDI file includes displaying (6088), as the audio file is recorded (e.g., in real-time), an indication of the corresponding MIDI notes. In some embodiments, if the audio file is recorded from a piano, displaying (6088), as the audio file is recorded, an indication of the corresponding MIDI notes, includes displaying, in the composition region (e.g., composition region 520), which piano key is played as the audio file is recorded. Similarly, if the audio file is recorded from a guitar, displaying (6088), as the audio file is recorded, an indication of the corresponding MIDI notes, includes displaying, in the composition region, which guitar string is played as the audio file is recorded. Similarly, if the audio file is recorded from a performer voice, displaying (6088), as the audio file is recorded, an indication of the corresponding MIDI notes, includes displaying, in the composition region, which note the performer is singing as the audio file is recorded. In some embodiments, the user may need to provide input to the DAW regarding what specifically the non-digital instrument is. Alternatively, the DAW may be able to automatically detect what the non-digital instrument is once the recording has started. The non-digital instrument may be indicated in the profile section 510 (e.g., “Grand piano”). In some embodiments, the user may need to provide input to the DAW regarding at least what categories (e.g., string instrument, human voice, etc.) the non-digital instrument belongs to, and the DAW may be able to further determine what specifically the non-digital instrument is (e.g., piano, guitar, male voice, etc.).

In some embodiments, importing (6060) the audio file includes, without user intervention, aligning (6090) the audio file with a rhythm of the first MIDI file. In some embodiments, aligning (6090) the audio file with a rhythm of the first MIDI file is based on one or more characteristics of one or more rhythms corresponding to the first MIDI file and/or the audio file. In some embodiments, the rhythm of the first MIDI file may have been chosen by the user before importing (6060) the audio file. In some embodiments, the rhythm of the first MIDI file may be chosen by the DAW automatically (e.g., without user intervention) after the first MIDI file is added to the composition by the user. In some embodiments, such automatic selection of the rhythm of the first MIDI file may be performed by the DAW based on one or more criteria provided by the user. Alternatively, such automatic selection of the rhythm of the first MIDI file may be performed by the DAW based on past alignment tasks. In some embodiments, aligning (6090) the audio file with a rhythm of the first MIDI file is based on one or more characteristics of one or more rhythms that are different from the rhythm of the first MIDI file.

In some embodiments, importing (6060) the audio file further includes, without user intervention, modifying (6100) a rhythm of the audio file based on the rhythm of the first MIDI file. In some embodiments, the modified rhythm of the audio file is different from the rhythm of the audio file that is aligned (6090) to the rhythm of the first MIDI file. In some embodiments, the modified rhythm of the audio file is the rhythm that is aligned (6090) to the rhythm of the first MIDI file.

In some embodiments, importing (6060) the audio file further includes displaying (6110) a representation of the audio file (e.g., segment 530) in the composition region (e.g., composition region 520). In some embodiments, the displayed representation of the audio file indicates that the audio file is audio rather than MIDI (e.g., comparing segment 530 and segment 570). In some embodiments, the displayed representation of the audio file may use a symbol (e.g., icon) specific to audio files to indicate that the audio file is audio rather than MIDI. In some embodiments, the displayed representation of the audio file may use a color specific to audio files to indicate that the audio file is in audio format rather than MIDI format.

In some embodiments, importing (6060) the audio file may further include modifying (6120) a pitch of the audio file based on one or more pitches in the first MIDI file.

In some embodiments, method 6000 may further include receiving (6130) a single request to export the composition to a notation format. In some embodiments, method 6000 may include receiving a single request to export the entire composition at once. In some embodiments, the single request is to export only a portion of the entire composition.

In some embodiments, method 6000 further includes in response to the single request to export the composition to a notation format, exporting (6140) the first MIDI file and the audio file to the notation format.

In some embodiments, the first MIDI file and the audio file are exported into a single file. In some embodiments, the first MIDI file and the audio file are exported into two different files. In some embodiments, the exported file(s) are saved on an electronic device (e.g., electronic device 102). In some embodiments, the exported file(s) are saved to a server (e.g., digital audio composition server 104) and can be downloaded via a DAW application (e.g., digital audio workstation application 222). In some embodiments, in response to the single request to export the composition to a notation format, method 6000 may further includes receiving a user input specifying where to save the exported file(s).

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method, comprising:
displaying, on a display of an electronic device, a user interface of a digital audio workstation (DAW), wherein:
the user interface for the DAW includes a composition region for generating a composition,
the composition region includes a representation of a first MIDI file that has already been added to the composition by a user, and
receiving a user input to import, into the composition region, an audio file;
in response to the user input to import the audio file, importing the audio file, including, without user intervention:
aligning the audio file with a rhythm of the first MIDI file;
modifying a rhythm of the audio file based on the rhythm of the first MIDI file; and
displaying a representation of the audio file in the composition region.

2. The method of claim 1, wherein importing the audio file comprises recording the audio file from a non-digital instrument.

3. The method of claim 1:
receiving a single request to export the composition to a notation; and
in response to the single request to export the composition to a notation format, exporting the first MIDI file and the audio file to the notation format.

4. The method of claim 1, wherein importing the audio file includes converting the audio file to a second MIDI file.

5. The method of claim 4, wherein converting the audio file to the second MIDI file comprises applying the audio file to a neural network system.

6. The method of claim 5, wherein the neural network system jointly predicts frame-wise onsets, pitch contours, and note activations.

7. The method of claim 6, wherein the neural network system post-processes the frame-wise onsets, pitch contours, and note activations to create MIDI note events with pitch bends.

8. The method of claim 6, wherein the neural network system is trained to predict frame-wise onsets, pitch contours, and note activations from a plurality of different instruments without retraining.

9. The method of claim 6, wherein the audio file includes polyphonic content, and the neural network system jointly predicts frame-wise onsets, pitch contours, and note activations for the polyphonic content.

10. The method of claim 4, wherein converting the audio file to the second MIDI file is performed in real-time.

11. The method of claim 1, wherein the DAW is displayed in a web browser.

12. The method of claim 4, wherein:
the second MIDI file includes MIDI notes corresponding to the audio file, and
the method further comprises displaying, as the audio file is recorded, an indication of the corresponding MIDI notes.

13. The method of claim 1, wherein importing the audio file, includes, without user intervention, modifying a pitch of the audio file based on one or more pitches in the first MIDI file.

14. An electronic device, comprising:
a display;
one or more processors;
memory storing one or more programs, the one or more programs including instructions for:
displaying, on the display of the electronic device, a user interface of a digital audio workstation (DAW), wherein:
the user interface for the DAW includes a composition region for generating a composition,
the composition region includes a representation of a first MIDI file that has already been added to the composition by a user, and
receiving a user input to import, into the composition region, an audio file;
in response to the user input to import the audio file, importing the audio file, including, without user intervention:
aligning the audio file with a rhythm of the first MIDI file;
modifying a rhythm of the audio file based on the rhythm of the first MIDI file; and
displaying a representation of the audio file in the composition region.

15. A non-transitory computer-readable storage medium storing one or more program comprising instructions that, when executed by an electronic device, cause the electronic device to perform a set of operations, comprising:
displaying, on a display of the electronic device, a user interface of a digital audio workstation (DAW), wherein:
the user interface for the DAW includes a composition region for generating a composition,
the composition region includes a representation of a first MIDI file that has already been added to the composition by a user, and
receiving a user input to import, into the composition region, an audio file;
in response to the user input to import the audio file, importing the audio file, including, without user intervention:
aligning the audio file with a rhythm of the first MIDI file;
modifying a rhythm of the audio file based on the rhythm of the first MIDI file; and
displaying a representation of the audio file in the composition region.
